(19) United States
(12) Patent Application Publication
(10) Pub. No.: US 2015/0154355 A1
(43) Pub. Date: Jun. 4, 2015

(54) HEALTH EXAMINATION DATA DISPLAYING METHOD, INSTRUMENT THEREOF AND NON-TRANSITORY COMPUTER READABLE STORAGE MEDIUM

(71) Applicant: INSTITUTE FOR INFORMATION INDUSTRY, Taipei (TW)

(72) Inventors: Fei-Lung LIN, Taipei City (TW); Cheng-Yu TSAI, Taipei City (TW); Hui-I HSIAO, Yunlin County (TW)

(73) Assignee: INSTITUTE FOR INFORMATION INDUSTRY, Taipei (TW)

(21) Appl. No.: 14/162,756

(22) Filed: Jan. 24, 2014

(30) Foreign Application Priority Data
Nov. 29, 2013 (TW) 102143799

(51) Int. Cl. G06F 19/00

(52) U.S. Cl. CPC G06F 19/321; G06F 19/3431

(57) ABSTRACT

The invention relates to a method to display health examination data in an electronic apparatus. First, at least one health examination data is gathered. The at least one health examination data is recoded in a health examination report. Then, the at least one health examination data is transformed to a graphic health examination data. Finally, the graphic health examination data is displayed in a display.

### RELATED APPLICATIONS

This application claims priority to Taiwan Application Serial Number 102143799, filed Nov. 29, 2013, which is herein incorporated by reference.

### BACKGROUND

1. Field of Invention

The invention relates to a data displaying method, and particularly relates to a health examination data displaying method and instrument thereof.

2. Description of Related Art

With the aging of population, health examination becomes more important in finding a disease or potential health problems. A typical health examination report includes so many different numbers representing various health states of an examined subject that it is very difficult to be completely understood. Therefore, the examined subject needs to consult a medical doctor or a professional for the interpretation of the health examination result. However, there exists possibility for the examined subject to overlook some crucial information or suggestion in the consulting process, which may results in unbearable consequence.

Moreover, the health examination report is printed and presented on a paper. When an examined subject is provided health examination reports from different organizations of health examination with various formats, it becomes more difficult for those to read and understand the reports. Moreover, since the health examination results are recorded in the paper reports, it is inconvenient for someone who would like to check the results anywhere and anytime.

Therefore, a comprehensible health examination report that includes easily understandable data for readers showing health status and additional health strategy is needed.

### SUMMARY

The present invention provides a method to display a graphic health examination data to make a user easily understand his health state. Moreover, an additional health strategy is provided to the user to make user manage his health by himself. The graphic health examination report can be stored in a portable electronic apparatus to provide user checking his health examination data anytime.

An aspect of the invention provides a method to display health examination data in an electronic apparatus. First, at least one health examination data is gathered. The at least one health examination data is recoded in a health examination report. Then, the at least one health examination data is transformed to a graphic health examination data. Finally, the graphic health examination data is displayed in a display,

Another aspect of the invention provides a non-transitory computer readable storage medium having a computer program. The computer program includes instruction to make a processor perform a method to display health examination data in an electronic apparatus. The method includes to gather at least one health examination data. The at least one health examination data is recoded in a health examination report. Then, the at least one health examination data is transformed to a graphic health examination data. Finally, the graphic health examination data is displayed in a display.

Another aspect of the invention provides an instrument to display health examination data. The instrument is disposed in an electronic apparatus. The instrument comprises a gathering module, a transforming module and a displaying module. The gathering module gathers at least one health examination data recoded in a health examination report. The transforming module transforms the at least one health examination data to a graphic health examination data. The display module displays the graphic health examination data.

In view of the above, a graphic health examination report is presented in the claimed invention. Therefore, a user can easily understand his health state and a corresponding disease risk. Moreover, a corresponding medical orders and an additional health strategy are provided to the user to help user to manage his health by himself. The graphic health examination report is stored in a portable electronic apparatus. Therefore, a user can check his health examination data anytime.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 illustrates a flow chart to display a health examination data according to an embodiment of the invention.

FIG. 2 illustrates a schematic diagram of using a bar chart to display a health examination data according to an embodiment of the invention.

FIG. 3 illustrates a schematic diagram of using a ratio chart to display a health examination data according to an embodiment of the invention.

FIG. 4 illustrates a schematic diagram of using a virtual body structure to display a health examination data according to an embodiment of the invention.

FIG. 5 illustrates a schematic diagram of a non-transitory computer readable storage medium.

FIG. 6 illustrates a schematic diagram of an instrument to display a health examination data according to an embodiment of the invention.

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

Typically, the health examination report is printed and presented on a paper. It is inconvenient for someone who would like to check the results anywhere and anytime. Moreover, a typical health examination report includes so many different numbers representing various health states of an examined subject that it is very difficult to be completely understood. Accordingly, in the claimed invention, a graphical health examination report is provided to the examined subject. In the graphical health examination report, all health examination data is presented by using a graphic table. Therefore, an examined subject can easily understand his health state. An additional health strategy is also presented in the graphical health examination report to replenish the medical orders. Furthermore, the graphic health examination report is stored in a portable electronic apparatus. Therefore, an examined subject can check his health examination data anytime.

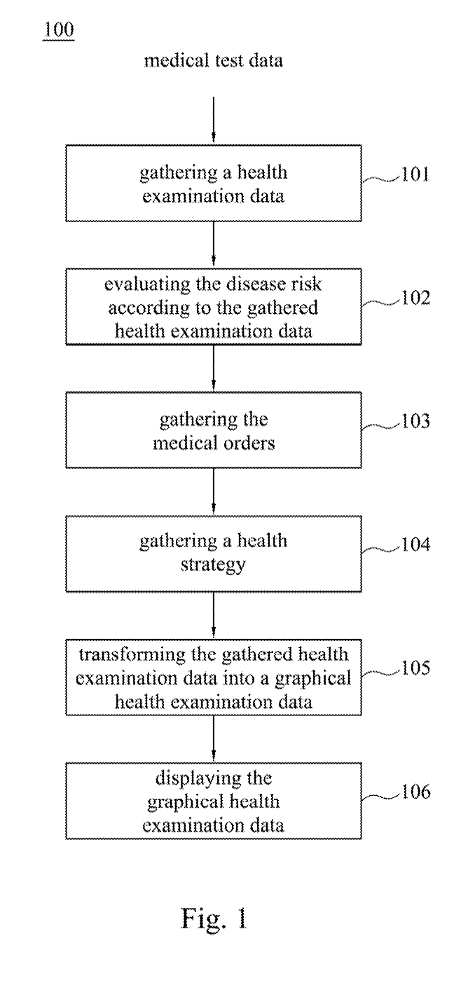

FIG. 1 illustrates a flow chart for displaying a health examination data according to an embodiment of the invention. The method 100 includes step 101 to gather a health examination data. The health examination data is gathered from a medical test data in a health examination report. The medical test data is generated when a person has a health checkup. For gathering required health examination data to display, when the health examination report is a paper report, the health examination report is photographed or scanned to transform this health examination report to a digitalized health examination report with a specific electronic file. On the other hand, when the health examination report has been a digitalized report, the report is transformed to a digitalized health examination report with this specific electronic file. Then, the required health examination data is gathered from the digitalized health examination report with the specific electronic file. In an embodiment, all the medical test data in the digitalized health examination report is gathered to be as the health examination data to display. In another embodiment, only unusual medical test data in the digitalized health examination report is gathered to be as the health examination data to display. In the following embodiment, unusual medical test data in the digitalized health examination report is gathered to be as the health examination data.

In step 102, the gathered health examination data is sorted to evaluate the disease risk. In an embodiment, the person having the health examination data is grouped into a group, such as an age group, a sex group or an industry group or a combination of the above group. Then, his health examination data is sorted in the group. The person may know whether or not his health examination data is very unusual in this group. Or, although his health examination data is unusual, the persons in this group always have the same unusual health examination data. Accordingly, a person can know his health state in this group. According to the sorted result, the person also can decide whether or not to change his work to improve his health state. On the other hand, the gathered health examination data is also used to evaluate the disease risk to remind the examined subject. In an embodiment, the health examination data about cardiovascular disease, such as blood pressure value, blood sugar value, cholesterol value or BMI value, is used to evaluate the cardiovascular disease risk according to the Framingham risk score or metabolic syndrome method. In another embodiment, the health examination data about colonic polyp is used to evaluate the colorectal cancer risk according to the Framingham risk score or metabolic syndrome method. It is noticed that other evaluation methods other than the above recited evaluation method may he used in the claimed invention.

In step 103, the medical orders in the digitalized health examination report is gathered. The typical medical orders are provided to the examined subject in the comprehensive suggestion description. That is, the suggestion of the typical medical orders focus on all the health examination data rather than focus on the unusual health examination data. Therefore, it is difficult for an examined subject to catch the main suggestion for the unusual health examination data, Accordingly, the claimed invention gathers the medical orders in the digitalized health examination report according to each health examination data. That is, the medical orders corresponding to different health examination data is extracted from the digitalized health examination report respectively and is displayed flowing the corresponding health examination data. Accordingly, the examined subject can clearly understand the suggestion of the medical orders for his unusual health examination data.

In step 104, a health strategy is gathered according to the health examination data. The health strategy teaches the examined subject how to improve the unusual health examination data in routine life to prevent the health aggravation. That is, the displayed health examination data in the claimed invention not only provides the medical orders originally existed in the digitalized health examination report but also provides an additional health strategy to replenish the medical orders to enhance the health examination report. In an embodiment, the health strategy is stored in a server. Each health examination data has a corresponding health strategy. In this embodiment, a health strategy is gathered according to the health examination data and is displayed flowing the corresponding health examination data. The health strategy may be customized according to age, sex or industry to enhance the function of the strategy.

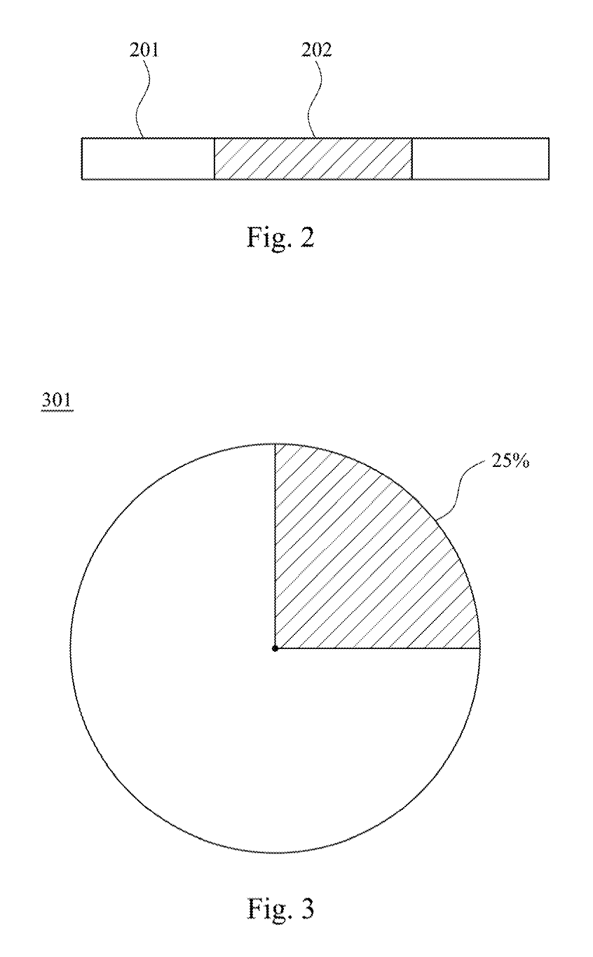

In step 105, the gathered health examination data is transformed to form a graphical health examination data. In the typical health examination report, so many different numbers are included to represent various health states of an examined subject that it is very difficult to be completely understood. Therefore, a graphical health examination data is presented to the examined subject in the claimed invention. In an embodiment, as shown in the FIG. 2, a bar chart 201 is used to display a health examination data. A range 202 is used to indicate the normal range of the health examination data. Different colors are used to indicate the distance of the examined subject's health examination data to the range 202 to present the orders of severity. In another embodiment, as shown in FIG. 3, a ratio chart 301 is used to display a health examination data. The ratio chart 301 can show a ratio of the health examination data, using different colors, in a group. For example, in an age group, the ratio chart 301 can tell the examined subject that 25% person in this age group has such health examination data. Accordingly, the examined subject can know that his health examination data whether or not belongs to a usual state in the age group. The grouped method can use age, sex or industry, In further embodiment, a virtual body structure 400 is used to display the health examination data. The organ corresponding to the unusual health examination data is marked by different colors to inform the examined subject which organ is unusual. Finally, in step 106, the graphical health examination data is displayed. Accordingly, a graphic health examination report is built. By the graphic health examination report, an examined subject can easily understand his health state and a corresponding disease risk and get a corresponding medical orders and health strategy.

FIG. 5 illustrates a schematic diagram of a non-transitory computer readable storage medium. The non-transitory computer readable storage medium 500 includes a computer program 501. The computer program 501 includes a lot of instruction to instruct a processor to perform the method 100 in FIG. 1. The computer program 501 is built by magnetizing the non-transitory computer readable storage medium 500.

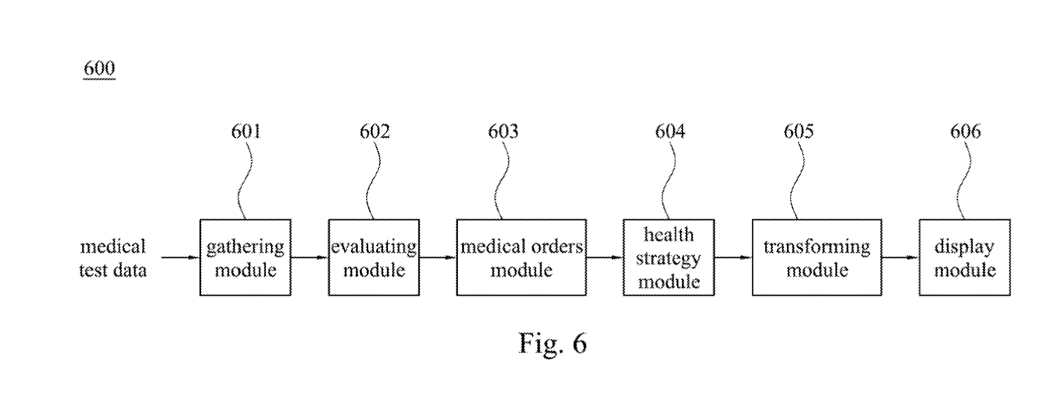

FIG. 6 illustrates a schematic diagram of an instrument to display a health examination data according to an embodiment of the invention. The instrument 600 includes a gathering module 601, an evaluating module 602, a medical orders module 603, a health strategy module 604, a transforming module 605 and a display module 606.

The gathering module 601 gathers a health examination data. The health examination data is gathered from a medical test data in a health examination report. When the health examination report is a paper report, the health examination report is photographed or scanned to transform this health examination report to a digitalized health examination report with a specific electronic file. On the other hand, when the health examination report has been a digitalized report, the report is transformed to a digitalized health examination report with this specific electronic file. Then, the gathering module 601 gathers the required health examination data from the digitalized health examination report with the specific electronic file.

The evaluating module 602 sorts the gathered health examination data and evaluates the disease risk. The gathering module 601 transfers the gathered health examination data to the evaluating module 602. The person having the health examination data is grouped into a group and is sorted by the evaluating module 602 according to a grouping standard, such as age, sex or industry. The person may know his health state in this group. On the other hand, the evaluating module 602 further uses the gathered health examination data to evaluate the disease risk. In an embodiment, the health examination data about cardiovascular disease, such as blood pressure value, blood sugar value, cholesterol value or BMI value, is used to evaluate the cardiovascular disease risk according to the Framingham risk score or metabolic syndrome method. It is noticed that other evaluation methods other than the above recited evaluation method may be used in the claimed invention.

The medical orders module 603 gathers the medical orders in the digitalized health examination report according to the health examination data. That is, the medical orders corresponding to different health examination data is extracted from the digitalized health examination report respectively and is displayed flowing the corresponding health examination data. Accordingly, the examined subject can clearly understand the suggestion of the medical orders for his unusual health examination data.

The health strategy module 604 gathers a health strategy according to the health examination data. The health strategy teaches the examined subject how to improve the unusual health examination data in routine life to prevent the health aggravation. That is, the displayed health examination data in the claimed invention not only provides the medical orders originally existed in the digitalized health examination report but also provides an additional health strategy to replenish the medical orders to enhance the health examination report. In an embodiment, the health strategy is stored in a server. Each health examination data has a corresponding health strategy. The health strategy may be customized according to age, sex or industry to enhance the function of the strategy.

The transforming module 605 transforms the gathered health examination data to a graphical health examination data. In an embodiment, as shown in the FIG. 2, a bar chart 201 is used to display a health examination data. Different colors are used to indicate the distance of the examined subject's health examination data to the normal range 202 to present the orders of severity. In another embodiment, as shown in FIG. 3, a ratio chart 301 is used to display a health examination data. The ratio chart 301 can show a ratio of the health examination data, using different colors, to make the examined subject know that his health state in a group. In further embodiment, a virtual body structure 400 is used to display the health examination data. The organ corresponding to the unusual health examination data is marked by different colors to inform the examined subject which organ is unusual.

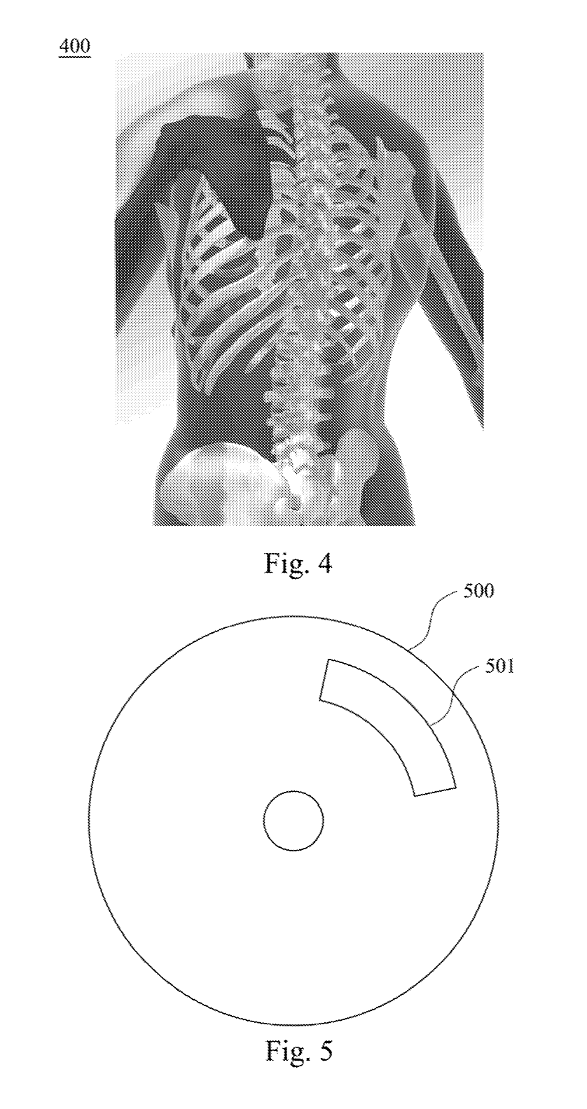

The display module 606 displays the graphical health examination data. In an example, all health examination data and corresponding normal range are displayed in the graphic health examination report. When the virtual body structure 400 in FIG. 4 is used to display the health examination data, the organ corresponding to unusual health examination data is marked by different colors to inform the examined subject which organ is unusual. When the examined subject can select the unusual health examination data, the display module 606 displays the corresponding disease risk evaluated by the evaluating module 602, the corresponding medical orders gathered by the medical orders module 603 and the corresponding health strategy gathered by the health strategy module 604 to the examined subject. The instrument 600 can be disposed in a portable electronic apparatus, such as a mobile phone or notebook. Therefore, an examined subject can check his health examination data anytime. Moreover, because the health examination data is stored in a portable electronic apparatus, when an examined subject talks with a doctor or a pharmacist, he can check the health examination data when needed to avoid using wrong data.

In view of the above, a graphic health examination report is presented in the claimed invention. Therefore, an examined subject can easily understand his health state and a corresponding disease risk. Moreover, a corresponding medical orders and an additional health strategy are provided to the examined subject to help examined subject to manage his health by himself. The graphic health examination report is stored in a portable electronic apparatus. Therefore, an examined subject can check his health examination data anytime.

Although the invention has been disclosed with reference to the above embodiments, these embodiments are not intended to limit the invention. It will he apparent to those of skills in the art that various modifications and variations can be made without departing from the spirit and scope of the invention. Therefore, the scope of the invention shall be defined by the appended claims.

What is claimed is:

1. A method to display health examination data in an electronic apparatus, comprising:
gathering at least one health examination data recoded in a health examination report;
transforming the at least one health examination data to a graphic health examination data; and
displaying the graphic health examination data.

2. The method of claim 1, further comprising evaluating a disease risk according to the at least one health examination data.

3. The method of claim 1, further comprising gathering medical orders of priority according to the at least one health examination data.

4. The method of claim 1, further comprising gathering a health strategy stored in a server according to the at least one health examination data.

5. The method of claim 1, wherein the graphic health examination data includes a virtual body structure, wherein the virtual body structure includes an organ corresponding to the at least one health examination data.

6. The method of claim 1, wherein different colors are marked in the graphic health examination data to present an order of priority in severity of the at least one health examination data.

7. The method of claim 1, wherein the graphic health examination data includes a ratio chart in a group, wherein the ratio chart shows a ratio of the at least one health examination data in the group.

8. The method of claim 7, wherein the group is an age group, a sex group, an industry group or a combination thereof.

9. A non-transitory computer readable storage medium having a computer program which includes instruction to make a processor perform a method to display health examination data in an electronic apparatus, the method comprising:
gathering at least one health examination data encoded in a health examination report;
transforming the at least one health examination data to a graphic health examination data; and
displaying the graphic health examination data.

10. An instrument in an electronic apparatus to display health examination data, comprising:
a gathering module to gather at least one health examination data recoded in a health examination report;
a transforming module to transform the at least one health examination data to a graphic health examination data; and
a display module to display the graphic health examination data.

11. The instrument of claim 10, comprising an evaluating module to evaluate a disease risk according to the at least one health examination data.

12. The instrument of claim 10, comprising a medical order module to gather medical orders of priority according to the at least one health examination data.

13. The instrument of claim 10, further comprising a health strategy module to gather a health strategy stored in a server according to the at least one health examination data.

14. The instrument of claim 10, wherein the graphic health examination data includes a virtual body structure, wherein the virtual body structure includes an organ corresponding to the at least one health examination data.

15. The instrument of claim 10, wherein different colors are marked in the graphic health examination data to present an order of priority in severity of the at least one health examination data.

16. The instrument of claim 10, wherein the graphic health examination data includes a ratio chart in a group, wherein the ratio chart shows a ratio of the at least one health examination data in the group.

17. The instrument of claim 16, wherein the group is an age group, a sex group, an industry group or a combination thereof.
